(19) United States
(12) Patent Application Publication
(10) Pub. No.: US 2026/0249294 A1
(43) Pub. Date: Aug. 27, 2026

(54) Observation Device

(71) Applicant: Donaldson Company, Inc., Bloomington, MN (US)

(72) Inventors: Joe A. Jaye, Crystal, MN (US); Isaac J. Laffey, Waterloo, IA (US); Robert O. Nelson, Eagan, MN (US)

(21) Appl. No.: 19/552,912

(22) Filed: Feb. 27, 2026

Related U.S. Application Data
(60) Provisional application No. 63/764,333, filed on Feb. 27, 2025.

(51) Int. Cl. B01L 3/00

(52) U.S. Cl. CPC B01L 3/502753; B01L 3/502723; B01L 2200/0684; B01L 2300/047; B01L 2300/0681; B01L 2300/069; B01L 2300/0858

(57) ABSTRACT

An observation device having an observation reservoir having an axial thickness and defining an observation volume. The observation reservoir has an observation wall extending through the observation reservoir, where the observation wall is transparent to one or more wavelengths of electromagnetic energy. A microporous membrane extends laterally across and abuts the observation volume and the observation wall.

### CROSS REFERENCE TO RELATED APPLICATION

This application claims the benefit of U.S. Provisional Application No. 63/764,333 filed 27 February 2025, the disclosure of which is incorporated by reference in its entirety.

### TECHNOLOGICAL FIELD

The present disclosure is generally related to a device. More particularly, the present disclosure is related to an observation device.

### SUMMARY

Some embodiments of the present technology relate to an observation device. The observation device has an observation reservoir having an axial thickness and defining an observation volume. The observation reservoir has an observation wall extending through the observation reservoir. The observation wall is transparent to one or more wavelengths of electromagnetic energy. The observation reservoir has a microporous membrane that extends laterally across and abuts the observation volume and the observation wall.

In some such embodiments, the observation wall forms a pillar within an outer lateral boundary of the observation volume. Additionally or alternatively, the pillar is central to the outer lateral boundary of the observation volume. Additionally or alternatively, the observation wall extends into the observation volume from an outer lateral boundary of the observation volume. Additionally or alternatively, the observation wall is outside of the observation volume. Additionally or alternatively, the observation device has a liquid source reservoir defining a source volume and a microfluidic channel extending laterally from the liquid source reservoir to the observation reservoir.

Additionally or alternatively, the observation device has a tray that includes the liquid source reservoir, the microfluidic channel, and the observation reservoir. Additionally or alternatively, the observation wall defines an observation area of at least 1 mm² that abuts the microporous membrane. Additionally or alternatively, the microporous membrane defines an air vent opening across a portion of the observation reservoir. Additionally or alternatively, the air vent opening has an area of less than 1 mm². Additionally or alternatively, the microporous membrane includes ePTFE. Additionally or alternatively, the microporous membrane includes an absorbent layer disposed between the ePTFE and the observation wall. Additionally or alternatively, a bond area couples the microporous membrane to the observation wall around an observation area.

The above summary is not intended to describe each embodiment or every implementation. Rather, a more complete understanding of illustrative embodiments will become apparent and appreciated by reference to the following Detailed Description and claims in view of the accompanying figures of the drawing.

### BRIEF DESCRIPTION OF THE DRAWINGS

The present technology may be more completely understood and appreciated in consideration of the following detailed description of various embodiments in connection with the accompanying drawings.

FIG. 1 is a perspective view of an example observation device consistent with the technology disclosed herein.

FIG. 2 is a perspective view of another example observation device consistent with the technology disclosed herein.

FIG. 3 is a perspective view of yet another example observation device consistent with the technology disclosed herein.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

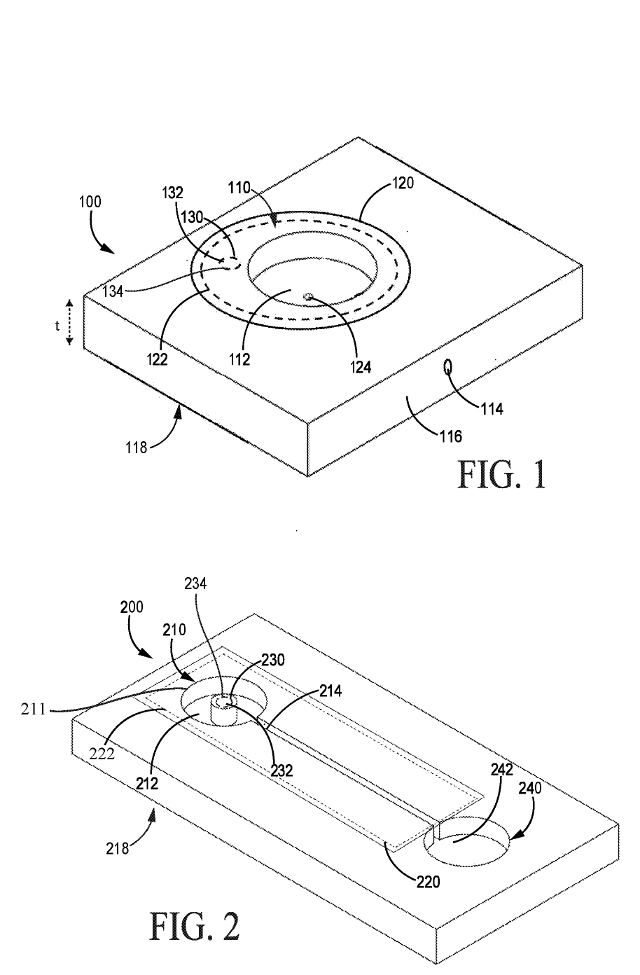

FIG. 1 is a perspective view of an example observation device 100 consistent with various embodiments. The observation device 100 is generally configured to separate a constituent from a liquid sample for observation. In some examples, the observation device 100 is configured to isolate a constituent in a liquid sample from other constituents in the liquid sample. In some implementations, the liquid sample can be blood, and the constituent that is separated from the blood for observation is plasma.

The observation device 100 generally has an observation reservoir 110, an observation wall 130, and a microporous membrane 120 coupled to the observation reservoir 110 and the observation wall 130. The observation reservoir 110 has a thickness t in the axial direction. The observation reservoir 110 defines an observation volume 112. The observation volume 112 can be positioned within the axial thickness t of the observation reservoir 110. The observation volume 112 is generally configured to contain a liquid sample. In some implementations, as discussed above, the liquid sample can be a sample of blood. The capacity of the observation volume 112 is not generally limited. In some embodiments, however, the observation volume 112 has a capacity of 3 to 15 microliters, 4 to 10 microliters, and, in some specific examples, 5 to 6 microliters.

The observation reservoir 110 generally includes the observation wall 130. The observation wall 130 defines an observation area 132 through which a portion of the liquid sample can be observed. In some examples, the observation device 100 is configured to isolate one or more constituents from the liquid sample at the observation wall 130. For example, the one or more constituents can be transferred from the observation volume 112 to a surface of the observation wall 130. The observation wall 130 is generally transparent to one or more wavelengths of electromagnetic energy, where “transparent” is used herein to mean that the observation wall 130 is configured to transmit at least 50%, 55%, 60%, 65%, 70%, 75%, 80%, 85%, or 90% of one or more wavelengths of electromagnetic energy. Such a configuration may advantageously allow analysis facilitated by measuring the passage of electromagnetic energy through the observation wall 130. In some embodiments, the observation wall 130 is transparent to one or more wavelengths in the optical spectrum.

The observation wall 130 generally extends axially through the observation reservoir 110 from the observation area 132 to an opposite observation area on the opposite axial side 118 of the observation reservoir 110. In some embodiments, the observation wall 130 extends through the axial thickness t of the observation reservoir 110. In various implementations, an emitter is configured to emit electromagnetic energy through the observation wall 130 at either (1) the observation area 132 or (2) the opposite observation area, and a sensor is configured to detect the electromagnetic energy that passed through the observation wall 130 at the other of the (1) observation area 132 or (2) the opposite observation area. The observation wall 130 can be constructed of a material and/or combinations of materials that facilitate sufficient transmission of select wavelengths in the electromagnetic spectrum, as discussed above. In some embodiments, the observation wall 130 is constructed of a clear polycarbonate film, such as a plurality of layers of polycarbonate film, or molded polycarbonate. Other example materials include acrylic, vinyl, polyethylene, polypropylene, polyolefins, polyvinylchloride (PVC) and the like.

The microporous membrane 120 of the observation device 100 generally extends laterally across the observation reservoir 110 and the observation wall 130. The microporous membrane 120 generally abuts the observation volume 112 and the observation wall 130. The microporous membrane 120 is generally coupled to the observation reservoir 110 around the observation volume 112 to form a seal 122 with the observation reservoir 110 around the observation volume 112. The seal 122 is around the perimeter of the microporous membrane 120 and surrounds the observation volume 112 and the observation area 132. The microporous membrane 120 can be coupled to the observation reservoir 110 with an adhesive and/or through a welding operation such as sonic welding or heat welding.

In various implementations, the microporous membrane 120 is an absorbent of one or more constituents in a liquid sample introduced to the observation volume. In particular, one or more constituents can be drawn into the pores of the microporous membrane 120 via capillary action. In various embodiments, the microporous membrane 120 is not an absorbent of the remaining constituents in the liquid sample that are not intended to be observed. In this way, the microporous membrane 120 is configured to isolate the desired constituent in a liquid sample from other constituents in the liquid sample. In one particular implementation, where the liquid sample is blood, the microporous membrane 120 is configured to absorb plasma from the blood sample. In some such implementations, the microporous membrane 120 is configured not to absorb red blood cells such that the plasma is isolated from the red blood cells.

More particularly, the microporous membrane 120 can be structured to exclude particular constituents of the liquid sample from being absorbed. For example, the microporous membrane 120 can have a pore size and pore distribution that prevents the absorption and lateral flow of some constituents of the liquid sample. In such examples, the microporous membrane 120 acts as a filter to prevent passage of some of the constituents into the microporous membrane 120 and, ultimately, the observation area 132.

The average pore size of the microporous membrane 120 will generally be defined based on the size of constituents that are intended to be excluded and the size of the constituents that are intended to be absorbed. The microporous membrane 120 may have an average pore size of 500 µm or less, 200 µm or less, 100 µm or less, 50 µm or less, 30 µm or less, 15 µm or less, 10 µm or less, 7 µm or less, 6 µm or less, 5 µm or less, or 1 µm or less. The porous substrate may have an average pore size of 0.1 µm or greater, 1 µm or greater, 3 µm or greater, 5 µm or greater, or 6 µm or greater. A method for measuring pore size is described in ASTM D6767-21. In example implementations specific to plasma analysis where the liquid sample is blood, the average pore size of the microporous membrane 120 may be 5 µm or less.

It is noted that, in a variety of embodiments, the microporous membrane is configured to be positioned vertically above the observation volume of the observation reservoir such that particular constituents of the liquid sample are drawn upwards into the pores of the microporous membrane by capillary action. Some other constituents of the liquid sample may settle towards a lower portion of the observation reservoir under the force of gravity. For example, in some such implementations where the observation volume is configured to receive blood, and plasma is the desired constituent for observation, white blood cells and red blood cells may sediment toward a lower portion of the observation reservoir due to gravitational forces. Plasma may float above the red and white blood cells and may be in contact with the microporous membrane. Spatial separation between the microporous membrane layer and the undesired constituents that settle to the bottom of the observation reservoir can increase fluid flux across the microporous membrane and reduce likelihood of pore occlusion by the undesired constituents.

In various embodiments, the microporous membrane 120 is configured to facilitate capillary action of the absorbed constituents in the liquid sample laterally across the microporous membrane 120, including over the observation wall 130 to the observation area 132.

The microporous membrane 120 is generally bonded to the observation wall 130 in a bond area 134. The microporous membrane 120 can be sealed to the observation wall 130 perimetrically around the observation area 132 in the bond area 134. In some embodiments the bond area 134 forms an outer lateral boundary of the observation area 132. Such a configuration may advantageously limit flow to the observation area 132 to the constituents absorbed by the microporous membrane 120 rather than all of the constituents in the liquid sample within the observation volume 112. The bond between the microporous membrane 120 and the observation wall 130 is generally configured to accommodate lateral flow of the absorbed constituents across the bond area 134 to the observation area 132. In some examples, the bond area 134 includes an adhesive that bonds the microporous membrane 120 to the observation wall 130. In another example, the bond area 134 is a weld area, such as a sonic weld or heat weld, that bonds the microporous membrane 120 to the observation wall 130. In some embodiments, the microporous membrane 120 is not bonded to the observation wall 130 within the observation area 132. In some other embodiments the microporous membrane 120 is bonded to the observation wall 130 within the observation area 132.

The observation area 132 is generally sized to facilitate sufficient energy transmission through the observation wall 130 to accommodate various emitters and sensors. In some examples, the observation area 132 has an area of 1 mm² or more, 2 mm² or more, 3 mm² or more, 4 mm² or more, 5 mm² or more, 6 mm² or more, 7 mm² or more, 8 mm² or more, 8 mm² or more, or even 10 mm² or more. In some examples, the observation area 132 has an area of 25 mm² or less, 20 mm² or less, 15 mm² or less, or 10 mm² or less. In some examples, the observation area 132 has an area from 1 mm² to 5 mm², but in some other embodiments the observation area 132 has an area from 10 mm² to 20 mm². In some examples, the size of the observation area 132 can depend on the thickness of the microporous membrane 120. For example, a relatively thicker microporous membrane 120 may advantageously absorb a higher volume of a desired constituent, which may allow for a decrease in the size of the observation area 132. The microporous membrane 120 can generally have a thickness from 10 µm to 500 µm.

The microporous membrane 120 can be constructed of a variety of materials and combinations of materials. In various examples, the microporous membrane 120 is transparent (at least in the axial direction) to one or more wavelengths of electromagnetic energy. As such, in examples where the microporous membrane 120 is constructed of multiple layers, each layer is transparent to one or more wavelengths of electromagnetic energy.

In some embodiments, the microporous membrane 120 is constructed of a single layer. In some such embodiments, the layer can be expanded polytetrafluoroethylene (ePTFE). In some other embodiments, the microporous membrane 120 is constructed of multiple layers. In some examples where the microporous membrane 120 is constructed of multiple layers, at least one layer can be a scrim or support layer that provides structural support for the rest of the layers. In some embodiments, the microporous membrane 120 is constructed of multiple layers of one or more microporous materials. In some embodiments, the microporous membrane 120 can be constructed of multiple layers of ePTFE.

In some embodiments, the microporous membrane 120 can have an absorbent layer and a lateral flow layer across the absorbent layer. The absorbent layer is generally disposed between the observation reservoir 110 and the lateral flow layer. In this way, the absorbent layer is configured to abut the observation volume 112 to absorb the desired constituent from the liquid sample. The absorbent layer can be disposed between the lateral flow layer and the observation wall 130. Example absorbent layers include polypropylene, polyethylene terephthalate (PET), polyethylene, glass fibers, ePTFE, cotton, or polyethersulfone. The lateral flow layer is configured to absorb the constituent from the absorbent layer and facilitate lateral translation of the constituent across the lateral flow layer, including over the observation wall 130. Example lateral flow layers include ePTFE or glass fiber.

In some embodiments, one or more layers of the microporous membrane 120 can include a coating. The coating may impart desirable surface properties to the microporous membrane 120. For example, in some examples, the microporous membrane 120 has a hydrophilic coating. In some other examples, the surface of the microporous membrane 120 is hydrophilic without a coating. Having hydrophilic surfaces may increase the wettability of the microporous membrane 120, which may advantageously increase absorption of water-based solutions. The microporous membrane 120 can be consistent with that described in PCT Pub. No. WO 2024/259157 A2, which is incorporated by reference in its entirety.

In the current example, the observation wall 130 is positioned outside of the observation volume 112. In particular, the observation wall 130 is positioned laterally outside of the observation volume 112. In some other embodiments, the observation wall 130 can be positioned within the observation volume 112, which will be described below.

In some examples, the microporous membrane 120 defines an air vent opening 124. The air vent opening 124 is generally positioned across a portion of the observation reservoir 110. The air vent opening 124 is generally in fluid communication with the observation volume 112 and the environment external to the observation volume 112. The air vent opening 124 is configured to facilitate airflow such as when the observation volume 112 is being filled with a sample liquid that displaces the air within the observation volume 112. Such a configuration may advantageously prevent the buildup of pressure within the observation reservoir 110. Such a configuration may evacuate air from the observation reservoir 110, which may advantageously prevent the air from becoming trapped in the observation reservoir 110 or the microporous membrane 120, which could otherwise interfere with electromagnetic signals. In some examples, the air vent opening 124 has a sufficiently small area that prevents the passage of the sample liquid there-through. In various examples, the air vent opening 124 has an area of less than or equal to 1 mm². In some embodiments, however, an air vent opening 124 can be greater than 1 mm².

The observation reservoir 110 generally has an inlet 114 in fluid communication with the observation volume. The inlet 114 is generally configured to facilitate the passage of a sample fluid from outside of the observation reservoir 110 to the observation volume 112. In the current example, the inlet 114 extends through a sidewall 116 of the observation reservoir 110. In some embodiments, the inlet 114 is sized to facilitate capillary flow of the sample fluid to the observation reservoir 110. In some other embodiments, the inlet 114 is sized to accommodate flow of the sample liquid under pressure or under the force of gravity to the observation reservoir 110. In some examples, the inlet 114 is sized to receive the sample fluid through a conduit that is brought into fluid communication with the inlet 114. In some such embodiments, the inlet 114 can be closed with a plug or valve once the volume of sample liquid in the observation volume 112 is sufficient. In some examples, the inlet 114 is a microfluidic channel. That and other configurations will be described below.

FIG. 2 is a perspective view of another example embodiment consistent with the technology disclosed herein. This example is generally consistent with FIG. 1 and the corresponding description unless contrary to FIG. 2 and/or the present discussion. Components discussed herein are likewise generally consistent with corresponding components discussed above unless contrary to the present figure and/or discussion. The observation device 200 generally has an observation reservoir 210, an observation wall 230, and a microporous membrane 220 coupled to the observation reservoir 210 and the observation wall 230. The observation reservoir 210 defines an observation volume 212.

The observation reservoir 210 generally has an observation wall 230. The observation wall 230 defines an observation area 232 through which a portion of the liquid sample can be observed. The observation wall 230 is generally transparent to one or more wavelengths of electromagnetic energy. The observation wall 230 generally extends axially through the observation reservoir 210 from the observation area 232 to an opposite observation area on the opposite axial side 218 of the observation reservoir 210. In the current example, the observation wall 230 is within the observation volume 212. The observation wall 230 forms a pillar within an outer lateral boundary 211 of the observation reservoir 210. In this example, the observation wall 230 is central to the outer lateral boundary 211 of the observation reservoir 210, although alternate configurations are also contemplated.

The microporous membrane 220 of the observation device 200 generally extends laterally across the observation reservoir 210 and the observation wall 230. The microporous membrane 220 generally abuts the observation volume 212 and the observation wall 230. The microporous membrane 220 is generally coupled to the observation reservoir 210 around the observation volume 212 to form a seal 222 with the observation reservoir 210 around the observation volume 212. The microporous membrane 220 can be coupled to the observation reservoir 210 with an adhesive and/or through a welding operation such as sonic welding or heat welding. The microporous membrane 220 can be consistent with microporous membranes discussed above with reference to FIG. 1.

The microporous membrane 220 is generally sealed to the observation wall 230 in a bond area 234. The microporous membrane 220 can be bonded or sealed to the observation wall 230 perimetrically around the observation area 232. The bond between the microporous membrane 220 and the observation wall 230 is generally configured to accommodate lateral flow of absorbed constituents across the bond area 234 to the observation area 232. The observation area 232 is generally sized to facilitate sufficient energy transmission through the observation wall 230 to accommodate various emitters and sensors, as discussed above with reference to FIG. 1.

In the current example, the microporous membrane 220 does not define an air vent opening, but in some other examples an air vent opening can be included.

The observation reservoir 210 generally has an inlet 214 in fluid communication with the observation volume 212. The inlet 214 is generally configured to facilitate the passage of a sample fluid from outside of the observation reservoir 210 to the observation volume 212. In the current example, the inlet 214 is a microfluidic channel extending to the observation volume 212. In some embodiments, the inlet 214 is sized to facilitate capillary flow of sample fluid to the observation reservoir 210. As such, the size of the microfluidic channel may be impacted by the particular sample fluid that the observation device 200 is configured to receive. A “microfluidic channel” is defined herein as a flow pathway having a cross-sectional area of less than 3 mm², where the cross-sectional area in an area perpendicular to the direction of fluid flow through the channel to the observation volume 212.

In the current example, the observation device 200 has a liquid source reservoir 240 defining a source volume 242. The source volume 242 is generally configured to receive a sample fluid from a user. For example, a user may transfer a liquid sample via a syringe, dropper, or the like, to the source volume 242. The microfluidic channel 214 extends laterally from the source volume 242 to the observation reservoir 210. The microfluidic channel 214 can be configured to transfer a liquid sample from the source reservoir 240 to the observation reservoir 210 through capillary action.

In the current example, the observation device 200 is a single, unitary component defining the observation reservoir 210, the microfluidic channel 214, and the source reservoir 240. In particular, the observation device 200 is a tray that defines the observation reservoir 210, the microfluidic channel 214, and the source reservoir 240. In various embodiments, the tray can be constructed of the same materials used to construct the observation wall 230, such that the entire device is transparent in the axial direction to one or more wavelengths of electromagnetic energy.

In the current example, the microporous membrane 220 extends across the observation volume 212 and the microfluidic channel 214. In this example, the microporous membrane 220 does not extend across the source volume 242. Such a configuration may advantageously allow a user to transfer a sample fluid directly to the source volume 242. In some other embodiments, however, the microporous membrane can extend across the source volume 242 as well. In such examples, the microporous membrane 220 can define an opening through which sample fluid can be introduced, or a sidewall of the source reservoir 240 can define an opening through which sample fluid is introduced.

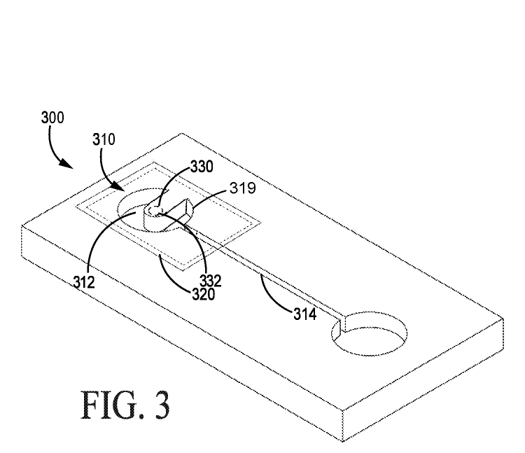

FIG. 3 is a perspective view of yet another example observation device 300 consistent with the technology disclosed herein. This example is generally consistent with FIGS. 1 and 2 and the corresponding descriptions unless contrary to FIG. 3 and/or the present discussion. Components discussed herein are likewise generally consistent with corresponding components discussed above unless contrary to the present figure and/or discussion. The observation device 300 generally has an observation reservoir 310, an observation wall 330 defining an observation area 332, and a microporous membrane 320 coupled to the observation reservoir 310 and the observation wall 330. The observation reservoir 310 defines an observation volume 312. In the current example, the observation area 332 is within the observation volume 312. However, unlike the example of FIG. 2, in the current example, the observation wall 330 extends into the observation volume 312 from an outer lateral boundary 319 of the observation volume 312.

Also, in the present example, the microporous membrane 320 extends across the observation volume 312, the observation wall 330, and a portion of the microfluidic channel 314.

### Exemplary Aspects

Aspect 1. An observation device comprising:

an observation reservoir having an axial thickness and defining an observation volume, and the observation reservoir comprises:

an observation wall extending through the observation reservoir, wherein the observation wall is transparent to one or more wavelengths of electromagnetic energy; and

a microporous membrane extending laterally across and abutting the observation volume and the observation wall.

Aspect 2. The observation device of any one of Aspects 1 and 3-13, wherein the observation wall forms a pillar within an outer lateral boundary of the observation volume.

Aspect 3. The observation device of any one of Aspects 1-2 and 4-13, wherein the pillar is central to the outer lateral boundary of the observation volume.

Aspect 4. The observation device of any one of Aspects 1-3 and 5-13, wherein the observation wall extends into the observation volume from an outer lateral boundary of the observation volume.

Aspect 5. The observation device of any one of Aspects 1-4 and 6-13, wherein the observation wall is outside of the observation volume.

Aspect 6. The observation device of any one of Aspects 1-5 and 7-13, further comprising:

a liquid source reservoir defining a source volume; and

a microfluidic channel extending laterally from the liquid source reservoir to the observation reservoir.

Aspect 7. The observation device of any one of Aspects 1-6 and 8-13, further comprising a tray that comprises the liquid source reservoir, the microfluidic channel, and the observation reservoir.

Aspect 8. The observation device of any one of Aspects 1-7 and 9-13, wherein the observation wall defines an observation area of at least 1 mm² that abuts the microporous membrane.

Aspect 9. The observation device of any one of Aspects 1-8 and 10-13, wherein the microporous membrane defines an air vent opening across a portion of the observation reservoir.

Aspect 10. The observation device of any one of Aspects 1-9 and 11-13, wherein the air vent opening has an area of less than 1 mm².

Aspect 11. The observation device of any one of Aspects 1-10 and 12-13, wherein the microporous membrane comprises ePTFE.

Aspect 12. The observation device of any one of Aspects 1-11 and 13, wherein the microporous membrane comprises an absorbent layer disposed between the ePTFE and the observation wall.

Aspect 13. The observation device of any one of Aspects 1-12, further comprising a bond area coupling the microporous membrane to the observation wall around an observation area.

It should be noted that, as used in this specification and the appended claims, the phrase “configured” describes a system, apparatus, or other structure that is constructed to perform a particular task or adopt a particular configuration. The word "configured" can be used interchangeably with similar words such as “arranged”, “constructed”, “manufactured”, and the like.

The term "about" as used herein can allow for a degree of variability in a value or range, for example, within 10%, within 5%, or within 1 % of a stated value or of a stated limit of a range and includes the exact stated value or range. The term "substantially" as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

What is claimed is:

1. An observation device comprising:
an observation reservoir having an axial thickness and defining an observation volume, and the observation reservoir comprises:
an observation wall extending through the observation reservoir, wherein the observation wall is transparent to one or more wavelengths of electromagnetic energy; and
a microporous membrane extending laterally across and abutting the observation volume and the observation wall.

2. The observation device of claim 1, wherein the observation wall forms a pillar within an outer lateral boundary of the observation volume.

3. The observation device of claim 2, wherein the pillar is central to the outer lateral boundary of the observation volume.

4. The observation device of claim 1, wherein the observation wall extends into the observation volume from an outer lateral boundary of the observation volume.

5. The observation device of claim 1, wherein the observation wall is outside of the observation volume.

6. The observation device of claim 1, further comprising:
a liquid source reservoir defining a source volume; and
a microfluidic channel extending laterally from the liquid source reservoir to the observation reservoir.

7. The observation device of claim 6, further comprising a tray that comprises the liquid source reservoir, the microfluidic channel, and the observation reservoir.

8. The observation device of claim 1, wherein the observation wall defines an observation area of at least 1 mm² that abuts the microporous membrane.

9. The observation device of claim 1, wherein the microporous membrane defines an air vent opening across a portion of the observation reservoir.

10. The observation device of claim 9, wherein the air vent opening has an area of less than 1 mm².

11. The observation device of claim 1, wherein the microporous membrane comprises ePTFE.

12. The observation device of claim 11, wherein the microporous membrane comprises an absorbent layer disposed between the ePTFE and the observation wall.

13. The observation device of claim 1, further comprising a bond area coupling the microporous membrane to the observation wall around an observation area.
